(19) United States
(12) Patent Application Publication
(10) Pub. No.: US 2015/0134109 A1
(43) Pub. Date: May 14, 2015

(54) SWITCHED CAPACITIVE DEVICES AND METHOD OF OPERATING SUCH DEVICES

(71) Applicant: General Electric Company, Schenectady, NY (US)

(72) Inventors: Rui Zhou, Niskayuna, NY (US); Manoj Ramprasad Shah, Latham, NY (US); Kiruba Sivasubramaniam Haran, Clifton Park, NY (US); Arthur Vorwerk Radun, Mason, OH (US); Enis Tuncer, Dallas, TX (US)

(73) Assignee: General Electric Company, Schenectady, NY (US)

(21) Appl. No.: 14/076,580

(22) Filed: Nov. 11, 2013

(51) Int. Cl. B25J 9/16; H02N 1/00

(52) U.S. Cl. CPC B25J 9/1615; H02N 1/006; Y10S 901/01
USPC 700/245; 310/300; 901/1

(57) ABSTRACT

A switched capacitive device includes a stator including a plurality of first electrodes extending substantially in a longitudinal dimension. The switched capacitive device also includes an armature including a plurality of second electrodes proximate the plurality of first electrodes. The plurality of second electrodes is translatable with respect to the plurality of first electrodes. The plurality of second electrodes extends substantially in the longitudinal dimension. The plurality of first electrodes and the plurality of second electrodes are configured to induce substantially linear motion of the second plurality of electrodes in the longitudinal dimension with respect to the first plurality of electrodes as a function of an electric field induced by at least a portion of the first plurality of electrodes.

### BACKGROUND

The field of the disclosure relates generally to actuators and motors and, more particularly, to machines including linear switched capacitance actuators and motors.

Many known actuators are electromechanical actuators (EMAs). At least some of these EMAs include at least one electric motor as a driving device, such motor coupled to one of an alternating current (AC) power source and a direct current (DC) power source. Some of these known motor-driven EMAs may also include a power transfer device, e.g., a geared transmission or a direct drive shaft. The motor may be powered through power electronics, e.g., insulated-gate bipolar transistors (IGBTs) to facilitate increases in efficiency. Many other known EMAs are hydraulically-driven and include an accumulator and a hydraulic pump/motor combination.

Such known EMAs are used extensively for operation of larger devices such as valves, dampers, and control surfaces on aircraft. However, they have some disadvantages for smaller applications, such as operation of robot appendages. One known measure of an efficiency of a robotic appendage is specific resistance. As used herein, the term “specific resistance” refers to a dimensionless measure of locomotive, or transport, energy efficiency. More specifically, specific resistance is numerically determined using the following equation:

∈=P/[m*g*v], Eq. (1)

where ∈ represents the specific resistance, P represents the power need to keep the object in motion, m is the mass of the object, g is the acceleration due to gravity, and v is the velocity of the object. Smaller values of specific resistance imply greater values of efficiency. An ideal frictionless device requiring nearly zero input power for continued motion has a specific resistance of approximately zero. However, most known devices have measureable losses due to component friction, impact, and air (or other fluid) resistance. Therefore, for typical devices, as the velocity increases, the specific resistance increases.

For example, devices requiring small actuators, e.g., state-of-the-art legged-robots, have a specific resistance that may be as much as two orders of magnitude greater than a specific resistance of living animals. The increased inefficiency of the robots over the live animals is due in large part to the actuation system. Hydraulic EMAs, e.g., hydraulic pumps in a power range between 500 Watts (W) and several kiloWatts (kW), and a weight between approximately 170 grams (g) and 1 kilogram (kg), have a peak actuator efficiency of approximately 90%. However, the power source efficiency is approximately 30% such that the resulting overall peak efficiency is approximately 27%. Also, the actuator power-to-weight ratio, i.e., total power output per unit weight, typically referred to as power density, is approximately 3.0 kiloWatts per kilogram (kW/kg), which is equivalent to the power-to-weight ratios of some large hydraulic actuators.

Similarly, magnetic linear EMAs of similar weights as the hydraulic actuators have a peak actuator efficiency in a range between approximately 80% and approximately 85% with a power source efficiency of greater than approximately 90% such that the overall peak efficiency is in a range between approximately 72% and approximately 77%. However, magnetic linear EMAs have a much lower power density than hydraulic actuators, e.g., approximately 0.3 kW/kg. The low power density and low efficiencies of known EMAs make them unattractive as candidates for actuators for devices that include robots.

To overcome such disadvantages of EMAs, switched capacitance motors (SCMs) have been proposed. Such SCMs are electrostatic motors that include a rotor and a stator operate in a manner similar to a switched reluctance motor (SRM). Both the rotor and stator include multiple electrodes that correspond to magnetic poles in an SRM. When a stator capacitor electrode pair is applied with a voltage, a rotor electrode will induce rotation in the rotor to align with the stator capacitor electrode pair. When the voltage on this stator electrode pair is removed, the appropriate next stator electrode pair that is not aligned with the rotor electrode is energized with a voltage to continue the rotational motion. Thus an external switching circuit is required to switch the stator excitation, though the machine may be configured to operate synchronously with three-phase power.

SCMs offer advantages over magnetic EMAs in that continuous electric current is not required to generate torque, thereby decreasing overall power consumption. Also, many standard components of magnetic EMAs, e.g., an iron core-type as a magnetic conductor and a yoke (or equivalent) are not required. Also, such SCMs require much less copper conductor. As such, the size, weight, efficiency, and cost of SCMs may be much lower than those for ECMs.

Many known SCMs are used in rotational applications, e.g., large scale motor drive applications that require approximately 100 Watts of power, rotational rates of approximately 10,000 revolutions per minute (rpm), approximately 95% efficiency, a specific force of approximately 15 Newtons per kilogram (N/kg), a torque density of approximately 0.5 Newton-meters per kilogram (N-m/kg), and a power density of approximately 0.5 kW/kg. However, the speed of such larger SCMs is too great for smaller applications, such as robot appendages. In addition, such SCMs typically require additional mechanical gearing and/or translation systems to convert the rotational motion to linear motion for applications, such as robot appendages. This requirement increases the complexity, weight, and cost of robotic appendages. Also, such SCMs have a power density on the order of magnitude of the magnetic EMAs described above, which is too low for effectively driving such robot appendages.

### BRIEF DESCRIPTION

In one aspect, a switched capacitive device is provided. The switched capacitive device includes a stator including a plurality of first electrodes extending substantially in a longitudinal dimension. The switched capacitive device also includes an armature including a plurality of second electrodes proximate the plurality of first electrodes. The plurality of second electrodes is translatable with respect to the plurality of first electrodes. The plurality of second electrodes extends substantially in the longitudinal dimension. The plurality of first electrodes and the plurality of second electrodes are configured to induce substantially linear motion of the second plurality of electrodes in the longitudinal dimension with respect to the first plurality of electrodes as a function of an electric field induced by at least a portion of the first plurality of electrodes.

In a further aspect, a method of operating a switched capacitive device is provided. The switched capacitive device includes a stator and an armature and device defines a longitudinal dimension. The method includes energizing at least a portion of a plurality of first electrodes within the stator. The plurality of first electrodes extends substantially in the longitudinal dimension. The method also includes inducing an electric field about the at least a portion of the first plurality of electrodes. The electric field is further induced about at least a portion of a plurality of second electrodes within the armature proximate the at least a portion of plurality of first electrodes. The plurality of second electrodes extends substantially in the longitudinal dimension. The method also includes inducing linear motion of the armature in the longitudinal direction.

In another aspect, a robot is provided. The robot has a body and a least one electric power source fixedly coupled to the body. The robot includes at least one appendage mechanism translatably coupled to the body. The at least one appendage mechanism includes at least one switched capacitive device configured to induce movement of the at least one appendage mechanism to generate a motion of the robot. The at least one switched capacitive device includes a stator including a plurality of first electrodes extending substantially in a longitudinal dimension. The at least one switched capacitive device also includes an armature including a plurality of second electrodes proximate the plurality of first electrodes. The plurality of second electrodes is translatable with respect to the plurality of first electrodes. The plurality of second electrodes extends substantially in the longitudinal dimension. The plurality of first electrodes and the plurality of second electrodes are configured to induce substantially linear motion of the second plurality of electrodes in the longitudinal dimension with respect to the first plurality of electrodes as a function of an electric field induced by at least a portion of the first plurality of electrodes.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary robotic device that includes exemplary robotic appendages that each include an exemplary switched capacitive device;

FIG. 2 is a schematic view of a switched capacitance motor (SCM) that may be used to facilitate a description of the principle of operation of SCMs that may be used in the robotic device shown in FIG. 1;

FIG. 3 is a schematic view of the basic exemplary architecture of the SCM shown in FIG. 2 taken along area 3 shown in FIG. 2;

FIG. 4 is a schematic view of an exemplary distribution of an electrostatic field within the SCM shown in FIG. 3;

FIG. 5 is a schematic view of the SCM shown in FIG. 3 with exemplary dielectric coatings;

FIG. 6 is a schematic view of SCM shown in FIG. 5 with exemplary dielectric coatings that have a permittivity lower than a gap fluid permittivity;

FIG. 7 is a schematic view of SCM shown in FIG. 5 with exemplary dielectric coatings that have a permittivity substantially similar to the gap fluid permittivity;

FIG. 8 is a schematic view of SCM shown in FIG. 5 with exemplary dielectric coatings that have a permittivity greater than the gap fluid permittivity;

FIG. 9 is a graphical view of the induced force within the SCMs shown in FIGS. 6, 7, and 8 as a function of time;

FIG. 10 is a schematic view of a plurality of exemplary voltage distributions within the SCM shown in FIG. 7;

FIG. 11 is a schematic longitudinal view of an exemplary linear SCM that may be used with the robotic device shown in FIG. 1;

FIG. 12 is a schematic side view of the linear SCM shown in FIG. 11;

FIG. 13 is a schematic perspective view of an alternative linear SCM that may be used with the robotic device shown in FIG. 1;

FIG. 14 is a more detailed schematic view of the linear SCM shown in FIG. 13 showing an exemplary armature circuit board and an exemplary stator circuit board installed therein;

FIG. 15 is a schematic view of the stator circuit board shown in FIG. 14;

FIG. 16 is a schematic view of the armature circuit board shown in FIG. 14;

FIG. 17 is a schematic perspective view of another alternative linear SCM that may be used with the robotic device shown in FIG. 1;

FIG. 18 is a schematic perspective view of an armature that may be used with the linear SCM shown in FIG. 17; and

FIG. 19 is a schematic view of an exemplary drive circuit that may be used with the linear SCMs shown in FIGS. 11, 13, and 17.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The switched capacitive devices embedded within the robotic systems described herein provide a cost-effective method for increasing the energy efficiency of the associated devices and robotic systems. Specifically, in order to achieve higher total energy efficiency for the actuation systems embedded within the robotic systems, a high power switched capacitance actuator (SCA) is used. More specifically, the embodiments described herein use a high power switched capacitance motor (SCM) as the SCA. As described herein, the principle of operation of the disclosed SCMs is based on a spatial change of electric fields rather than based on conventional magnetic fields. The SCMs described herein offer advantages over electromagnetic machines that include, without limitation, sufficient torque generation without using continuous current, removing the requirement of using an iron core as a magnetic conductor, eliminating the need for a yoke, and significantly decreasing the amount of copper in the actuators, thereby decreasing weight and costs of the actuators.

Also, specifically, the SCAs described herein are linear, direct drive SCMs without a transmission gear. Therefore, the embodiments described herein further facilitate decreasing the weight of actuation systems used in mobile and/or translatable machines. The embodiments described herein also increase the range of available force of the actuation systems while being highly efficient over a large force range. Moreover, the devices, systems, and methods described herein include high frequency drive circuits that include high voltage, wide band gap (WBG) devices such as high voltage, silicon carbide (SiC), metal-oxide-semiconductor field-effect transistor (MOSFET) devices. The increased operating frequency is facilitated by reducing the size of the electrodes in the actuators and using quick-acting WBG devices. In addition, the embodiments described herein use machine geometries that significantly enhance the amount of surface area used to induce translation of the SCMs. Furthermore, the machine geometries described herein significantly reduce the “air gap” within the SCMs and the remaining gap volume is filled with a dielectric fluid having a high dielectric permittivity that enhances operation, such as ultra-pure water.

Furthermore, specifically, the embodiments described herein include using ferroelectric materials to coat the stator/rotor electrodes to introduce field saturation with the benefits of reduced voltage for the same energy converted just as saturation reduces the current in a switched reluctance motor (SRM). The embodiments described herein also include new insulation coatings, i.e., unfilled thermoplastics and/or nanodielectric thermoplastics for insulation coatings.

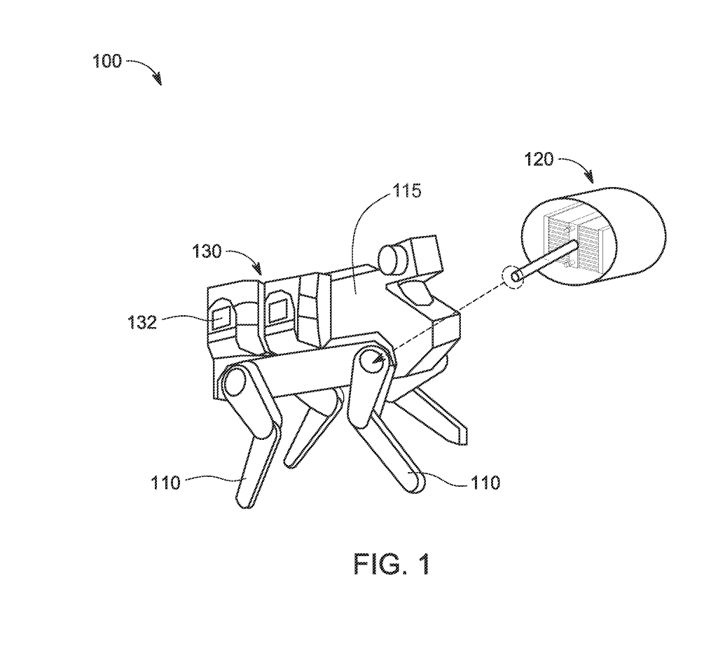

FIG. 1 is a schematic view of an exemplary robotic device, i.e., a legged robot 100 that includes exemplary robotic appendages 110 coupled to a robot body 115. In the exemplary embodiment, four appendages 110 are shown. Alternatively, robotic device 100 includes any number of appendages 110 that enables operation of robotic device 100 as described herein. Each of robotic appendages 110 includes a switched capacitive device, i.e., a switched capacitance actuator (SCA), and more specifically, a switched capacitance motor (SCM) 120. Legged robot 100 also includes an independent electric power supply system 130 coupled to robot body 115. In the exemplary embodiment, system 130 is a plurality of direct current (DC) batteries 132.

Alternative embodiments of robotic devices include, without limitation, assembly line robots. Such assembly line robots typically include a single robotic arm that includes a SCM receiving DC power from an alternating current (AC) source through a rectification system.

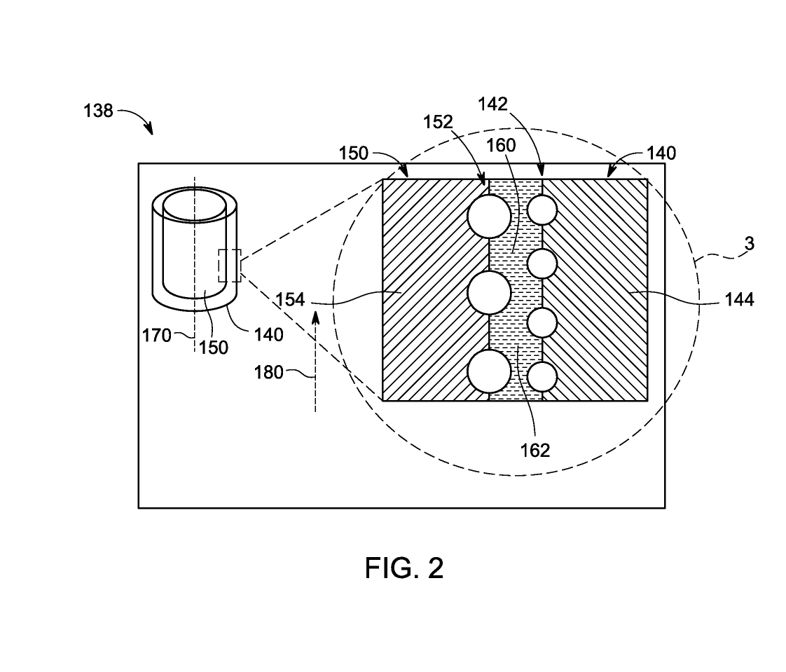

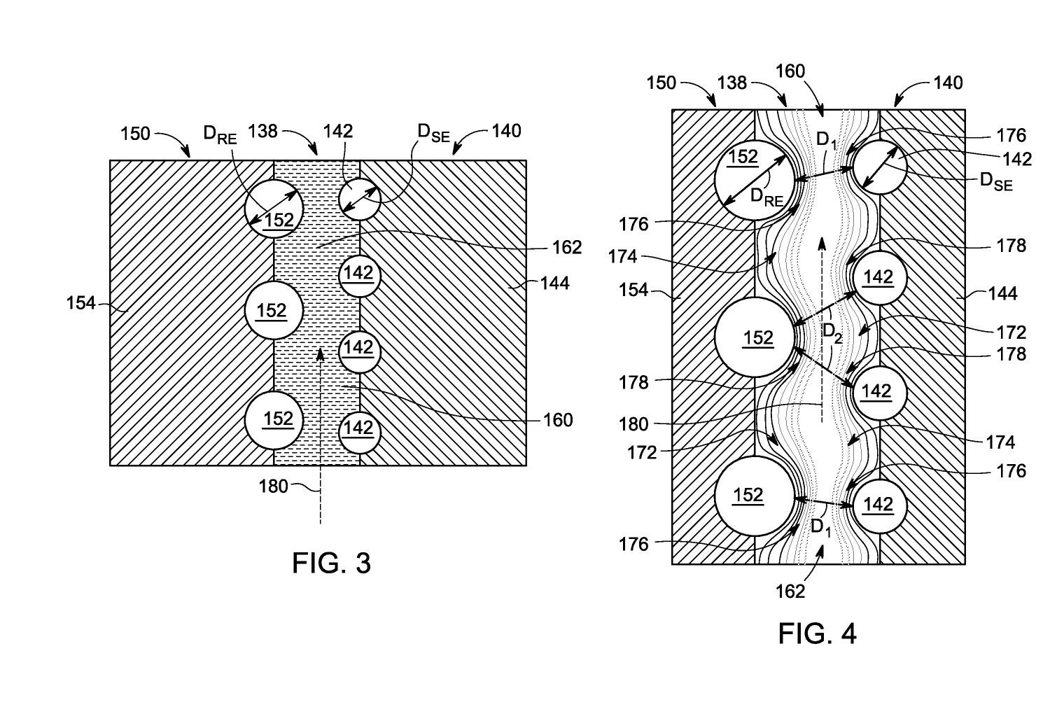

FIG. 2 is a schematic view of a cylindrical SCM 138. FIG. 3 is a schematic view of the basic exemplary architecture of SCM 138 taken along area 3 (shown in FIG. 2). FIG. 4 is a schematic view of an exemplary distribution of an electrostatic field within SCM 138. A cylindrical configuration for SCM 138 is used to facilitate a description of the principle of operation of SCM 120 (shown in FIG. 1).

In general, the principle of operation of SCM 138 is similar to other electrostatic motors, e.g., switched reluctance motors (SRMs) (not shown). SCM 138 includes a stator 140 that includes a plurality of stator electrodes 142 embedded within an epoxy composite 144, e.g., and without limitation, FR-4 that facilitates structural support of stator electrodes 142 and has a predetermined permittivity. SCM 138 also includes a rotor 150 that includes a plurality of rotor electrodes 152 embedded within an epoxy composite 154, e.g., and without limitation, FR-4 that facilitates structural support of stator electrodes 152. Rotor electrodes 152 are ring-shaped and have a diameter D_{RE} that is greater than a diameter D_{SE} of ring-shaped stator electrodes 142 (diameters D_{RE} and D_{SE} only shown in FIGS. 3 and 4). There are a greater number of stator electrodes 152 than rotor electrodes 152, i.e., a four-to-three, respectively, arrangement. Both stator 140 and rotor 150 are substantially cylindrical and stator 140 extends about rotor 150 to define a substantially annular gap 160 that is filled with a dielectric fluid 162, e.g., and without limitation, air pressurized to approximately 12 atmospheres and sulfur hexafluoride gas (SF₆) pressurized to approximately 4 atmospheres. SCM 138 defines an axial centerline 170 (only shown in FIG. 2).

In operation, stator electrodes 142 and rotor electrodes 152 correspond to the magnetic poles of an SRM. When an adjacent pair of stator electrodes 142 is energized with a DC voltage, an electrostatic field 172 (only shown in FIG. 4) is induced within gap 160. Electrostatic field 172 includes a plurality of low density distribution regions 174 proximate those regions in gap 160 between adjacent stator electrodes 142 and adjacent rotor electrodes 152 substantially parallel to axial centerline 170. Electrostatic field 172 also includes a plurality of intermediate density distribution regions 176 proximate those regions in gap 160 having nonaligned stator electrodes 142 and rotor electrodes 152. Electrostatic field 172 further includes a plurality of high density distribution regions 178 proximate those regions in gap 160 having aligned stator electrodes 142 and rotor electrodes 152. The strength of the electrostatic coupling, i.e., the density of the field distribution is proportional to the distance between stator electrodes 142 and rotor electrodes 152. Therefore, high density distribution regions 178 and intermediate density distribution regions 176 are proportional to distance D₁ and distance D₂, respectively. High density distribution regions 178 induce electric field distribution values of approximately 36 kilovolts (kV) per millimeter (mm), i.e., 36 kV/mm.

Moreover, when an adjacent pair of stator electrodes 142 is energized with a DC voltage, a proximate rotor electrode 152 rotates to align with stator electrodes 142. Once the adjacent pair of stator electrodes 142 and proximate rotor electrode 152 are aligned, the voltage on this pair of stator electrodes 142 is removed and the appropriate next pair of stator electrodes 142 that is not aligned with proximate rotor electrode 152 is energized with the DC voltage to continue the rotational motion as shown by arrow 180. In the exemplary embodiment, stator electrodes 142 are energized to a value of approximately +3000 volts DC and rotor electrodes 152 are energized to approximately −3000 volts DC. Alternatively, any voltages are used that enable operation of SCM 138 as described herein.

To increase and more evenly distribute the force exerted on rotor 150, multiple stator electrodes 142 may be energized substantially simultaneously, e.g., without limitation, every third stator electrode 142. To facilitate such simultaneous energization, an external switching circuit (not shown) may be used to switch the excitation of stator electrodes 142. Also, SCM 138 may also be energized through a synchronous three-phase power alternating current (AC) system.

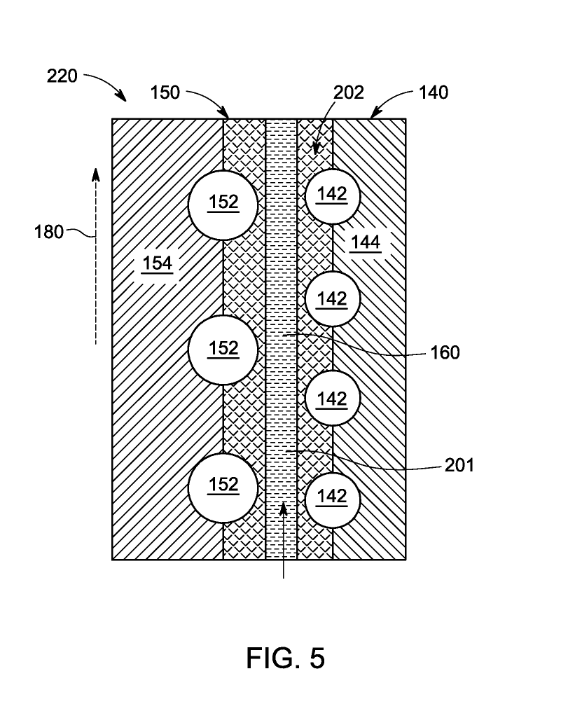

FIG. 5 is a schematic view of an exemplary SCM 200 that is similar to SCM 138 (shown in FIG. 3) with the exception that SCM 200 includes dielectric coatings 202 on stator 140 and rotor 150. In addition, gap 160 is filled with a fluid 201 including either ultrapure water or SF₆ at predetermined pressures, ultrapure water also having a high permittivity value. Coatings 202 extend into gap 160 to substantially embed electrodes 142 and 152 within coatings 202. Also, coatings 202 on electrodes 142 and 152 facilitate improving performance of SCM 200 by increasing corona and surface flashover voltage, and reducing a potential for any ferroelectric effects.

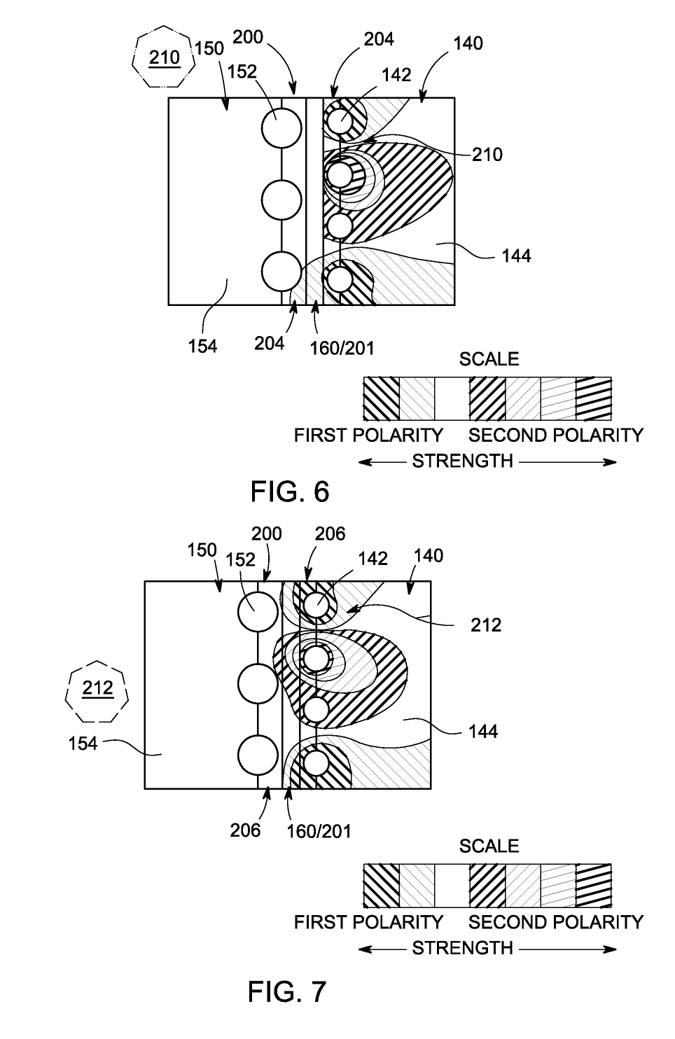

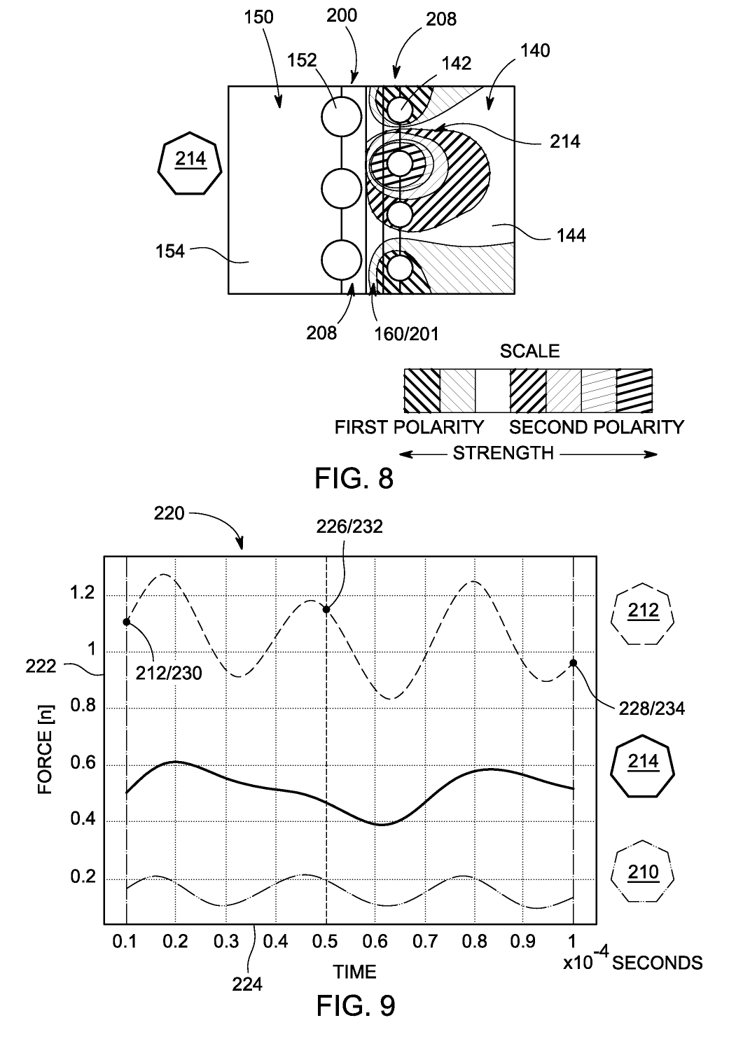

FIG. 6 is a schematic view of SCM 200 with exemplary dielectric coatings 204 that have a permittivity lower than a permittivity of fluid 201 in gap 160. FIG. 7 is a schematic view of SCM 200 with exemplary dielectric coatings 206 that have a permittivity substantially similar to the permittivity of fluid 201 in gap 160. FIG. 8 is a schematic view of SCM 200 with exemplary dielectric coatings 208 that have a permittivity greater than the permittivity of fluid 201 in gap 160. FIGS. 6, 7, and 8 show electric field distributions 210, 212, and 214, respectively, at 10 microseconds (10 μs). FIGS. 6, 7, and 8 also show a scale that includes a strength of a first polarity and a strength of a second polarity.

FIG. 9 is a graphical view, i.e., graph 220 of the induced force within SCM 200 as a function of time for each of the three dielectric coatings 204, 206, and 208 (shown in FIGS. 6, 7, and 8, respectively), and the respective electric field distributions 210, 212, and 214. Graph 220 includes a Y-axis 222 that represents induced force in gap 160 (shown in FIGS. 6-8) in Newtons (N) extending from 0 N to 1.3 N in 0.2 N increments. Graph 220 also includes an X-axis 224 that represents time in seconds extending from 0.1 seconds to 1 second in increments of 0.1 seconds. FIGS. 6, 7, and 8 show electric field distributions 210, 212, and 214, respectively, at 10 microseconds (10 μs), and this time is shown with a vertical dashed line in FIG. 9 at 0.1*10⁻⁴ seconds.

As shown in FIGS. 6-9, SCM 200, with dielectric coatings 206 that have a permittivity substantially similar to the permittivity of fluid 201 in gap 160, induces the strongest electric field distributions 212 that extend from stator 140 into rotor 150, and therefore induce the highest force values on rotor 150. In contrast, SCM 200, with dielectric coatings 208 that have a permittivity greater than the permittivity of fluid 201 in gap 160, induces the second strongest electric field distributions 212 and the second strongest force values. Also, in contrast, SCM 200, with dielectric coatings 204 that have a permittivity less than the permittivity of fluid 201 in gap 160, induces the weakest electric field distributions 210 and the weakest force values.

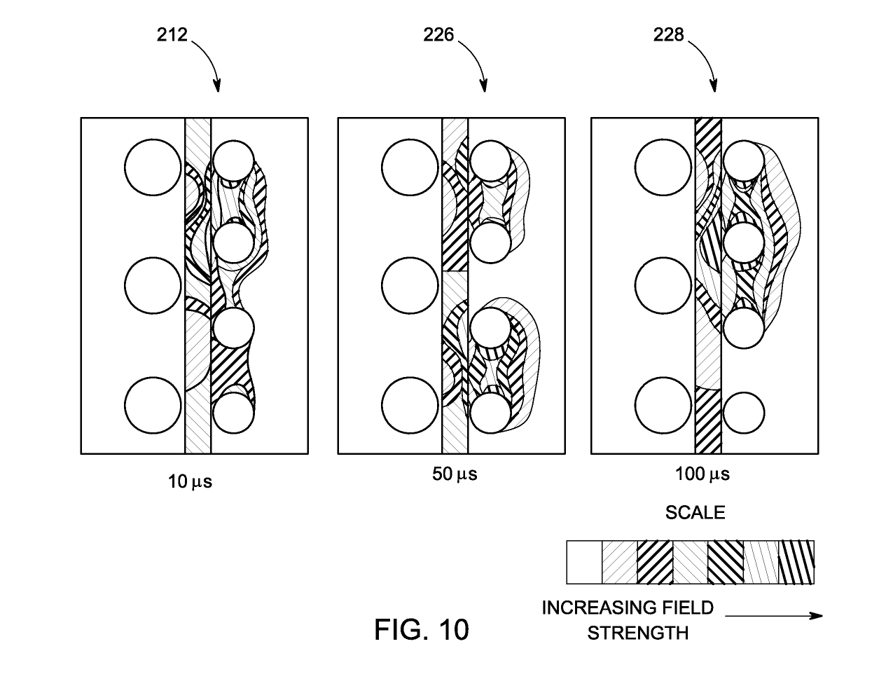

FIG. 10 is a schematic view of a plurality of exemplary voltage distributions 212, 226, and 228 within SCM 200 with exemplary dielectric coatings 208 (shown in FIG. 8) that have a permittivity greater than the permittivity of fluid 201 in gap 160 (both shown in FIG. 8). FIG. 10 includes a scale for the field strength associated with the voltage distributions, the field strength increasing from a zero, or white, value. Electric field distributions 212, 226, and 228 correspond with data points 230, 232, and 234 in FIG. 9, respectively, at 0.1*10⁻⁴ seconds, 0.5*10⁻⁴ seconds, and 1.0*10⁻⁴ seconds, respectively. Electric field distributions 212 and 226 have similar distributions in gap 160, and therefore have similar force values, i.e., approximately 1.1 N to approximately 1.15 N. In contrast, electric field distribution 218 has a lower distribution in gap 160 than distributions 212 and 226. Therefore, electric field distribution 218 induces a lower value of force, i.e., approximately 0.95 N.

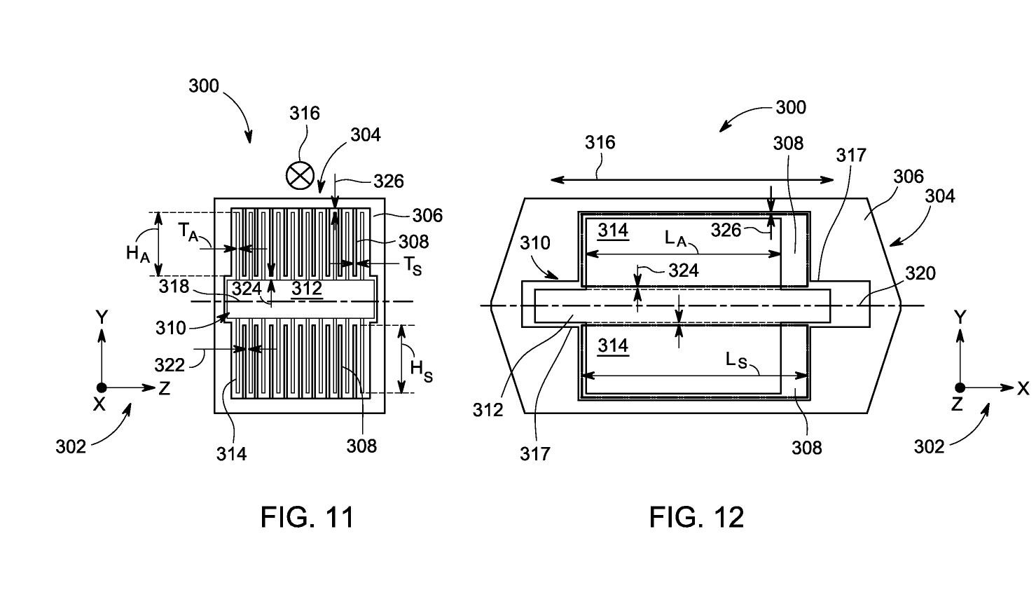

FIG. 11 is a schematic longitudinal view of an exemplary linear SCM 300 that may be used with robotic device 100 as an exemplary embodiment of SCM 120 (both shown in FIG. 1). FIG. 12 is a schematic side view of linear SCM 300. A coordinate system 302 includes an x-axis representative of a longitudinal direction of linear SCM 300, a y-axis representative of a height of linear SCM 300, and a z-axis representative of a transverse direction of linear SCM 300. Linear SCM 300 includes a stator assembly 304 that includes a stator block 306 and plurality of stator electrodes 308 coupled to stator block 306. In the exemplary embodiment, stator electrodes 308 are formed integrally with stator block 306 such that stator assembly 304 is substantially unitarily formed. Alternatively, stator electrodes 308 are coupled to stator block 306 using any methods that enable operation of linear SCM 300 as described herein, including, without limitation, soldering and brazing. Also, in the exemplary embodiment, stator electrodes 308 are substantially rectangular in profile with a longitudinal length value L_{S} along the x-axis (only shown in FIG. 12), a height value H_{S} along the y-axis, and a thickness value T_{S} along the z-axis (both only shown in FIG. 11). Alternatively, stator electrodes 308 have any shape that enables operation of linear SCM 300 as described herein. Further, stator block 306 and stator electrodes 308 are formed from any materials that enable operation of linear SCM 300 as described herein. Stator assembly 304 is coupled to electric power supply system 130 (shown in FIG. 1).

Linear SCM 300 also includes an armature assembly 310 that includes an armature center piece 312 and a plurality of armature electrodes 314 coupled to armature center piece 312. In the exemplary embodiment, armature electrodes 314 are formed integrally with armature center piece 312 such that armature assembly 310 is substantially unitarily formed. Alternatively, armature electrodes 314 are coupled to armature center piece 312 using any methods that enable operation of linear SCM 300 as described herein, including, without limitation, soldering and brazing. Also, in the exemplary embodiment, armature electrodes 314 are substantially rectangular in profile with a longitudinal length value L_{A} along the x-axis (only shown in FIG. 12), a height value H_{A} along the y-axis, and a thickness value T_{A} along the z-axis (both only shown in FIG. 11). Alternatively, armature electrodes 314 have any shape that enables operation of linear SCM 300 as described herein. Further, armature center piece 312 and armature electrodes 314 are formed from any materials that enable operation of linear SCM 300 as described herein. Armature assembly 310 is linearly translatable with respect to stator assembly 304 and armature center piece 312 is coupled to any device requiring linear motion 316 in the longitudinal direction as induced by linear SCM 300. Armature assembly 310 is supported through a plurality of bearings 317 (only shown in FIG. 12) that are any type of bearings that enable operation of linear SCM 300 as described herein, including, without limitation, sleeve bearings.

Armature center price 312 defines a transverse centerline axis 318 (only shown in FIG. 11) and a longitudinal centerline axis 320 (only shown in FIG. 12). Stator electrodes 308 and armature electrodes 314 substantially parallel to each other and are interdigitated such that stator electrodes 308 extend toward centerline axes 318 and 320 and armature electrodes 314 extend away from centerline axes 318 and 320. Stator electrodes 308 and armature electrodes 314 define a plurality of electrode gaps 322 (only shown in FIG. 11) therebetween. Stator electrodes 308 and armature center price 312 define a plurality of stator electrode gaps 324. Armature electrodes 314 and stator block 306 define a plurality of armature electrode gaps 326.

In the exemplary embodiment, gaps 322, 324, and 326 are filled with a high permittivity, low-viscosity, dielectric fluid (not shown in FIGS. 11 and 12) similar to dielectric fluid 162 (shown in FIGS. 2, 3, and 4) and/or dielectric fluid 201 (shown in FIG. 5). Also, stator electrodes 308 and armature electrodes 314 include formed layers of dielectric coatings (not shown in FIGS. 11 and 12) similar to dielectric coatings 206 (shown in FIG. 7) that have a permittivity substantially similar to the gap fluid permittivity. As such, due to the relationship between the gap fluid and the electrode coatings, relatively strong electric field distributions (not shown) are induced between stator electrodes 308 and armature electrodes 314 and relatively strong force values proportional to the electric field distributions are induced on armature assembly 310.

Also, in the exemplary embodiment, the gap fluid and bearings 317 are configured for high frequency wave excitation and high frequency repetition rates along the x-axis in direction of motion 316. High frequency excitation facilitates use of liquids with high dielectric permittivity, e.g., and without limitation, ultrapure water. This is due to the functionality of linear SCM 300 originating with the electric field and the charge that is generated through the capacitive coupling between stator electrodes 308 and armature electrodes 314 via dielectric displacement, i.e., the dielectric flux density. The high dielectric permittivity of the gap fluid facilitates improving the dielectric flux displacement vector, i.e., the vector that is a product of the three-dimensional electric field flux and a dielectric constant associated with the gap fluid. In addition to facilitating strong electric field distributions between stator electrodes 308 and armature electrodes 314, the gap fluid has lubricant characteristics that facilitate operation of linear SCM 300 at high repetition rates for extended period of time. Furthermore, the use of high frequency excitation fields facilitates increasing a dielectric breakdown strength through decreasing ion mobility within the gap fluid. Therefore, in addition to ultrapure water as used in the exemplary embodiment, such gap fluids may include, without limitation, vegetable oil, silicone oil, perfluorinated oils, and mineral oils.

In operation, stator assembly 304 receives high frequency electric power (discussed further below). The high frequency electric power is transmitted to stator electrodes 308 and a high frequency electric field is induced about electrodes 308, thereby electromagnetically coupling armature electrodes 314 to stator electrodes 308. Such electromagnetic coupling is enhanced through the high permittivity, low-viscosity, dielectric fluid in gaps 322, 324, and 326 and the dielectric coatings extending over electrodes 308 and 314. The electric current is transmitted longitudinally through stator assembly 304. Therefore, the induced electromagnetic coupling between electrodes 308 and 314 travels in the direction of the electric current and induces a force on armature assembly 310 in proportion to the strength of the electromagnetic coupling. As such, for a first polarity of electric current, armature assembly 310 translates, or travels in a first longitudinal direction 316 substantially parallel to the x-axis and stator electrodes 308. Similarly, for a second polarity of electric current, armature assembly 310 travels in a second longitudinal direction 316 opposite to the first longitudinal direction. As the polarity reverses as a function of the excitation frequency, armature assembly 310 travels back and forth to generate linear motion in any device attached thereto.

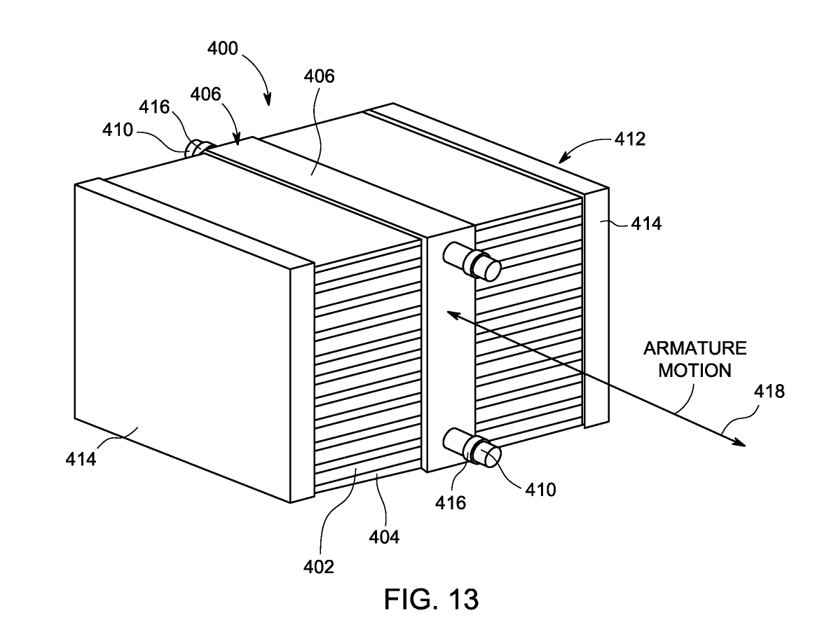

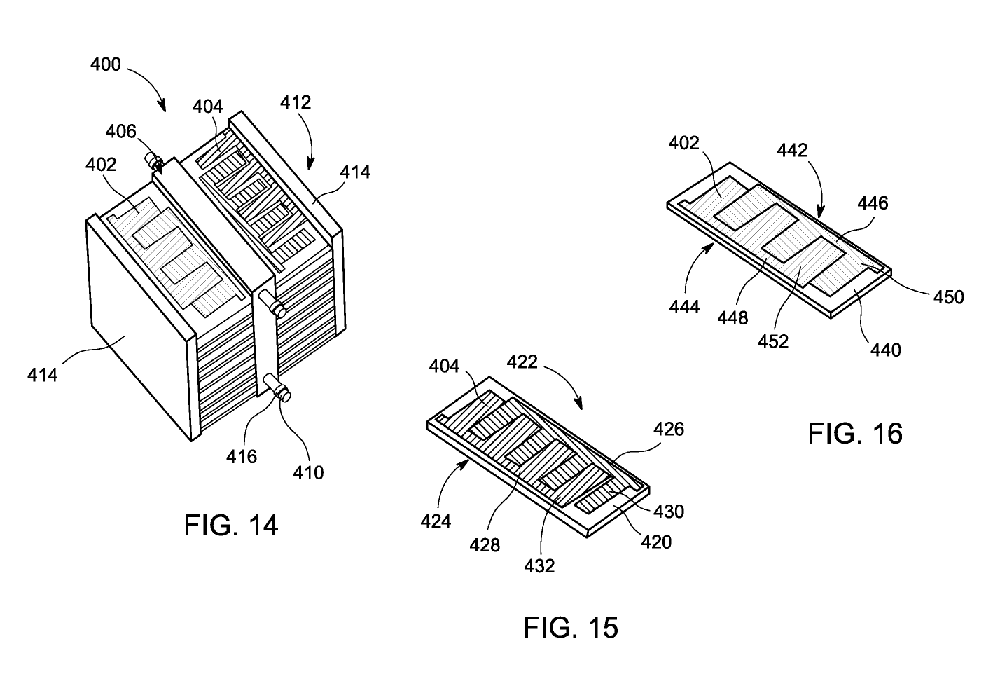

FIG. 13 is a schematic perspective view of an alternative linear SCM 400 that may be used with robotic device 100 as an exemplary embodiment of SCM 120 (both shown in FIG. 1). FIG. 14 is a more detailed schematic view of linear SCM 400 showing an exemplary armature circuit board 402 and an exemplary stator circuit board 404 installed therein.

In this alternative embodiment, linear SCM 400 includes an armature assembly 406 that includes an armature center piece 408 and twenty (20) armature circuit boards 402. Armature center piece 408 includes four shafts 410 (only three shown). Armature circuit boards 402 are manufactured with a precise predetermined thickness and dovetailed into center piece 408 with precise slots (not shown) defined therein. Linear SCM 400 also includes a stator assembly 412 that includes two side plates 414, twenty-two (22) stator circuit boards 404, and four bearings 416 (only three shown). Stator circuit boards 404 are manufactured with a precise predetermined thickness and dovetailed into side plates 414 with precise slots (not shown) defined therein. Stator circuit boards 404 and armature circuit boards 402 are substantially parallel to each other. Armature assembly 406 is linearly translatable with respect to stator assembly 412.

Armature center piece 408 and side plates 414 are fabricated from electrically insulated structural materials to hold circuit boards 404 and 402, respectively, such that a gap (not shown) of predetermined dimensions is defined. Such electrically insulated structural materials include any combination of, without limitation, thermosets and thermoplastics. Thermosets would be epoxies either unfilled or filled with fillers and fiberglass to improve mechanical and electrical properties. Thermoplastics include selections from a plurality of engineering plastics, e.g., without limitation, polypropylene, polyetherimide, and polycarbonates that may be either filled or unfilled with fillers and fiberglass to improve mechanical and electrical properties.

FIG. 15 is a schematic view of stator circuit board 404 and FIG. 16 is a schematic view of armature circuit board 402. Stator circuit boards 404 are configured as externally energized electrodes and armature circuit boards 402 are configured as induced electrodes. Therefore, stator circuit boards 404 are coupled to a positive and a negative polarity electric power source associated with electric power supply system 130 (shown in FIG. 1) through any bus connection system that enables operation of linear SCM 400 as described herein.

In the exemplary embodiment, circuit board 404 includes a stator substrate 420. Circuit board 402 also includes a positive polarity energizing stator electrode 422 and a negative polarity energizing stator electrode 424 coupled to substrate 420. Each of electrodes 422 and 424 includes a base portion 426 and 428, respectively, and a plurality of interdigitated portions 430 and 432, respectively, coupled to base portions 426 and 428, respectively. Positive polarity energizing stator electrode 422 and negative polarity energizing stator electrode 424 are coupled to the positive polarity and negative polarity, respectively, portions of electric power supply system 130 through any bus connection system that enables operation of linear SCM 400 as described herein.

Similarly, circuit board 402 includes an armature substrate 440. Circuit board 402 also includes a positive polarity induced armature electrode 442 and a negative polarity induced armature electrode 444 coupled to substrate 440. Each of electrodes 442 and 444 includes a base portion 446 and 448, respectively, and a plurality of interdigitated portions 450 and 452, respectively, coupled to base portions 446 and 448, respectively.

Referring to FIGS. 1, 13, 14, 15, and 16, in operation, for inducing forward motion of robotic device 100 through forward motion of linear SCM 400 (an embodiment of SCM 120) and one of appendages 110, positive polarity energizing stator electrode 422 is energized with a voltage of positive polarity from electric power supply system 130. As the wave of positive polarity voltage transmits through electrode 422, a positive polarity voltage is progressively induced along positive polarity induced armature electrode 442 such that a force is induced along electrode 442 to move electrode 442 in the direction of, and concurrently with, the traveling wave front in electrode 422. Therefore, electrode 442 attempts to align with electrode 422. Positive polarity energizing stator electrode 422 induces the voltages and the forces in adjacent positive polarity induced armature electrodes 442 directly above and/or directly below electrode 422. Operation of linear SCM 400 is timed such that as armature assembly 406 approaches the predetermined end of forward travel, positive polarity energizing stator electrode 422 is de-energized and discharges the positive polarity voltage.

Substantially simultaneously, negative polarity energizing stator electrode 424 is energized with a voltage of negative polarity from electric power supply system 130. As the wave of negative polarity voltage transmits through electrode 424, a negative polarity voltage is progressively induced along negative polarity induced armature electrode 444 such that a force is induced along electrode 444 to move electrode 444 in the direction of, and concurrently with, the traveling wave front in electrode 424. Therefore, electrode 444 attempts to align with electrode 424. Negative polarity energizing stator electrode 424 induces the voltages and the forces in adjacent negative polarity induced armature electrodes 444 directly above and/or directly below electrode 424. The positive polarity wave front and the negative polarity wave front travel in directions in direct opposition to each other and induce movement of armature assembly 406 in opposing directions as indicated by arrow 418 (only shown in FIG. 13).

Operation of linear SCM 400 is timed such that as armature assembly 406 approaches the predetermined end of reverse travel, negative polarity energizing stator electrode 424 is de-energized and discharges the negative polarity voltage. Substantially simultaneously, positive polarity energizing stator electrode 422 is energized with a voltage of positive polarity from electric power supply system 130 and the process repeats itself.

Operation of robotic device 100 through forward motion is enhanced through synchronized operation of each linear SCM 400 for each associated appendage 110. Also, in order to induce reverse motion of robotic device 100 through reverse motion of linear SCMs 400 and associated appendages 110, the order of energization of positive polarity energizing stator electrodes 422 and negative polarity energizing stator electrodes 424 is reversed from that described above for forward motion.

In the exemplary embodiment, as the surface area (sometimes referred to as the “air gap area”) of armature circuit boards 402 and stator circuit boards 404 subjected to an electric field increases, the power density and force in direction of motion increases. Additionally, as the distance between armature circuit boards 402 and stator circuit boards 404 is decreased, the values of the induced electrostatic forces therebetween increase. Therefore, some embodiments of linear SCM 400 are configured such that the gaps defined between circuit boards 402 and 404 are filled with dielectric solid layers and/or dielectric liquid between circuit boards 402 and 404 to facilitate a smaller predetermined gap size with increased electric field coupling, reduced friction, and a smaller potential for abrasion.

Also, in the exemplary embodiment, materials for armature circuit boards 402 and stator circuit boards 404 are selected to facilitate decreasing the overall weight of linear SCM 400. For example, and without limitation, circuit boards 402 and 404 may include thin layers of conductive metal film and the remaining structure and dielectric layers may be made of polymer, or composites of polymer and other dielectric or structural particles or fibers to reduce the total mass. Such fabrication materials and techniques may be expanded to include the larger components of SCM 400, e.g., and without limitation, armature stator side plates 414.

In some alternative embodiments, the final assembly of armature assembly 406 and stator assembly 412 may be performed with precision molding of a polymer with the associated electrodes as inserts accurately positioned in a mold. Alternatively, the electrodes may be inserted into precisely machined slots in supporting structures. In both cases, post assembly run-in can be used to smooth out the interfering dielectric layer between relatively moving electrodes.

Referring to FIGS. 13, 14, 15, and 16, and 19 (discussed below), in operation, stator assembly 412 receives high frequency electric power (discussed further below). The high frequency electric power is transmitted to stator circuit boards 404 and a high frequency electric field is induced within armature circuit boards 402, thereby electromagnetically coupling armature circuit boards 402 to stator circuit boards 404. Such electromagnetic coupling may be enhanced through high permittivity, low-viscosity, dielectric fluid (not shown in FIGS. 13-16) in the gaps between circuit boards 402 and 404 and dielectric coatings (not shown in FIGS. 13-16) extending over circuit boards 402 and 404. The electric current is transmitted longitudinally through stator assembly 412. Therefore, the induced electromagnetic coupling between circuit boards 402 and 404 travels in the direction of the electric current and induces a force on armature assembly 406 in proportion to the strength of the electromagnetic coupling and armature assembly 406 moves in the direction of arrow 418 (only shown in FIG. 13).

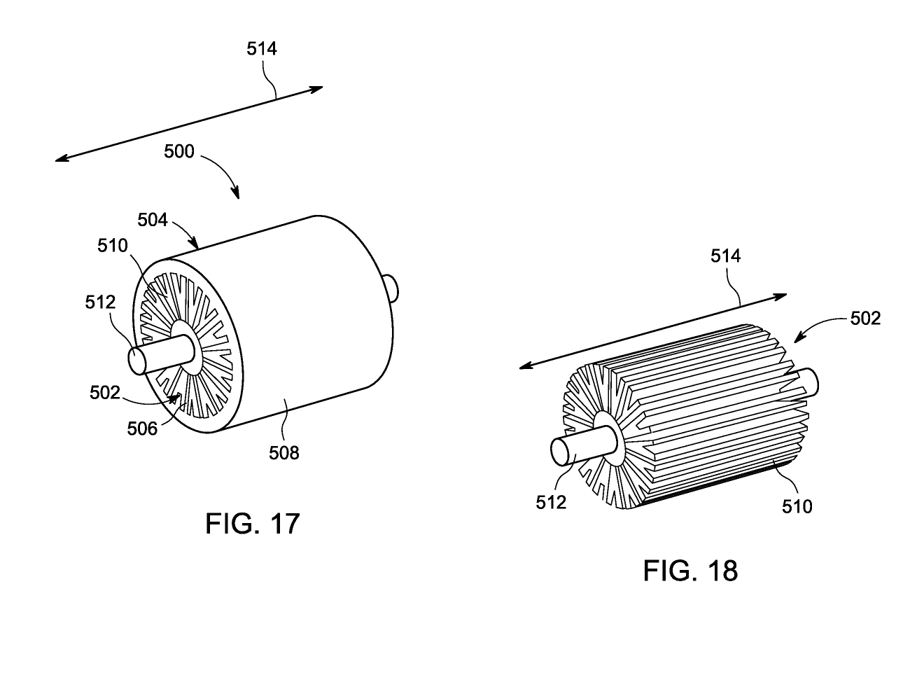

FIG. 17 is a schematic perspective view of another alternative linear SCM 500 that may be used with robotic device 100 (shown in FIG. 1). FIG. 18 is a schematic perspective view of an armature assembly 502 that may be used with linear SCM 500 (shown in FIG. 17). Linear SCM 500 includes a substantially cylindrical stator assembly 504 extending about substantially cylindrical armature assembly 502. Stator assembly 504 includes a plurality of stator circuit boards 506 coupled to a stator casing 508 that is coupled to electric power supply system 130 (shown in FIG. 1) through any bus connection system that enables operation of linear SCM 500 as described herein. Armature assembly 502 includes a plurality of armature circuit boards 510 coupled to, and radially extending outward from, an armature rotor 512. Stator circuit boards 506 are similar to stator circuit boards 404 (shown in FIGS. 13, 14, and 15). Armature circuit boards 510 are similar to armature circuit boards 402 (shown in FIGS. 13, 14, and 16).

Due to the geometric relationship between a rectangular design, e.g., linear SCM 400 (shown in FIGS. 13 and 14) and substantially cylindrical linear SCM 500, for similarly sized circuit boards and a similar number of circuit boards, the “air gap area” for linear SCM 500 is slightly greater than that for linear SCM 400. Operation of linear SCM 500 is similar to that of linear SCM 400 and motion of armature assembly 502 is shown though directional arrow 514.

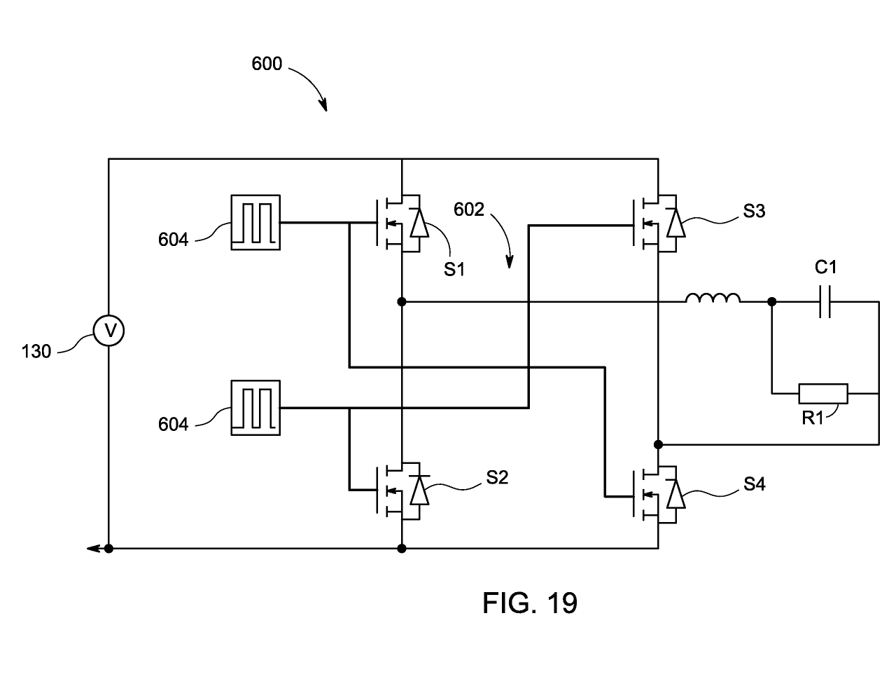

FIG. 19 is a schematic view of an exemplary drive circuit 600 that may be used with linear SCMs 300, 400, and 500 (shown in FIGS. 11, 13, and 17, respectively). In the exemplary embodiment, drive circuit 600 is a parallel resonant converter. Alternatively, any drive circuit that enables operation of linear SCMs 300, 400, and 500 as described herein are used. In the exemplary embodiment, SCMs 300, 400, and 500 are shown as a capacitor Cr in parallel with a load resistor R₁. Drive circuit 600 includes an H-bridge configuration 602 coupled to a resonant inductor Lᵣ. H-bridge 602 includes four semiconductor switches S₁, S₂, S₃, and S₄ that are high voltage, wide band gap (WBG) devices such as, without limitation, high voltage, quick acting, silicon carbide (SiC), metal-oxide-semiconductor field-effect transistor (MOSFET) devices. Such SiC MOSFETs facilitate increased efficiency due to decreased power losses, increased power density, and a high temperature operation capability as compared to other semiconductor based devices such as insulated bipolar gate transistors (IGBTs). H-bridge 602 is coupled to plurality of pulse converters 604 and is operated at a constant frequency and a 50% duty cycle to provide a square wave excitation to the resonant tank circuit, i.e., Lᵣ, and Cᵣ. The resonant tank and switching frequency is predetermined to achieve a predetermined certain voltage gain. The switching frequency is similar to the resonant frequency to achieve a good sinusoidal output, and usually operates above the resonance frequency to achieve a zero-voltage turn-on for the semiconductor switches S₁, S₂, S₃, and S₄. For example, and without limitation, such switching frequencies may be approximately 15 kiloHertz (kHz) and such resonant frequencies may be approximately 12.5 kHz.

The above-described switched capacitive devices embedded within exemplary robotic systems provide a cost-effective method for increasing the energy efficiency of the associated devices and robotic systems. Specifically, in order to achieve higher total energy efficiency for the actuation systems embedded within the robotic systems, a high power switched capacitance actuator (SCA) is used. More specifically, the embodiments described herein us a high power switched capacitance motor (SCM) as the SCA. As described herein, the principle of operation of the disclosed SCMs is based on a spatial change of electric fields rather than based on conventional magnetic fields. The SCMs described herein offer advantages over electromagnetic machines that include, without limitation, sufficient torque generation without using continuous current, removing the requirement of using an iron core as a magnetic conductor, eliminating the need for a yoke, and significantly decreasing the amount of copper in the actuators, thereby decreasing weight and costs of the actuators.

Also, specifically, the above-described SCAs are linear, direct drive SCMs without a transmission gear. Therefore, the embodiments described herein further facilitate decreasing the weight of actuation systems used in mobile and/or translatable machines. The embodiments described herein also increase the range of available force of the actuation systems while being highly efficient over a large force range. Moreover, the devices, systems, and methods described herein include high frequency drive circuits that include high voltage, wide band gap (WBG) devices such as high voltage, silicon carbide (SiC), metal-oxide-semiconductor field-effect transistor (MOSFET) devices. The increased operating frequency is facilitated by reducing the size of the electrodes in the actuators and using quick-acting WBG devices. In addition, the embodiments described herein use machine geometries that significantly enhance the amount of surface area used to induce translation of the SCMs. Furthermore, the machine geometries described herein significantly reduce the “air gap” within the SCMs and the remaining gap volume is filled with a dielectric fluid having a high dielectric permittivity that enhances operation, such as ultra-pure water.

Furthermore, specifically, the above-described embodiments include using ferroelectric materials to coat the stator/rotor electrodes to introduce field saturation with the benefits of reduced voltage for the same energy converted just as saturation reduces the current in a switched reluctance motor (SRM). The embodiments described herein also include new insulation coatings, i.e., unfilled thermoplastics and/or nanodielectric thermoplastics for insulation coatings.

An exemplary technical effect of the methods, systems, and apparatus described herein includes at least one of: (a) increasing the energy efficiency of switched capacitance actuators (SCA)/switched capacitance motors (SCM); (b) increasing the energy efficiency of robotic systems through high power SCAs/SCMs; (c) replacing conventional magnetic field-based actuator devices with SCAs/SCMs based on a spatial change of electric fields; (d) inducing sufficient torque through high power SCAs/SCMs without transmission of current continuously; (e) decreasing the weight of the SCAs/SCMs used in robotic assemblies by eliminating iron cores as magnetic conductors, yokes, and transmission gearing, and significantly decreasing the amount of copper in the SCAs/SCMs; (f) increasing the operating frequency of SCAs/SCMs by reducing the size of the electrodes in the actuators and using quick-acting, high voltage, SiC MOSFET-type WBG devices; and, (g) extending the lengths of the armature circuit boards and the stator circuit boards proximate to each other, thereby increasing the surface areas of each of the armature and the stator, increasing the strengths of the associated electric fields, the power densities generated within the SCAs/SCMs, and the forces in the direction of motion.

Exemplary embodiments of switched capacitive devices embedded within legged robotic systems are described above in detail. The high power SCAs/SCMs, and methods of operating such systems and devices are not limited to the specific embodiments described herein, but rather, components of systems and/or steps of the methods may be utilized independently and separately from other components and/or steps described herein. For example, the methods may also be used in combination with other systems requiring highly efficient movement of translatable devices, and are not limited to practice with only the robotic systems, and methods as described herein. Rather, the exemplary embodiment can be implemented and utilized in connection with many other machinery applications that are currently configured to receive and accept SCAs/SCMs, e.g., and without limitation, appendaged robotic systems in automated assembly facilities.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A switched capacitive device comprising:
a stator comprising a plurality of first electrodes extending substantially in a longitudinal dimension; and
an armature comprising a plurality of second electrodes proximate said plurality of first electrodes, said plurality of second electrodes translatable with respect to said plurality of first electrodes, said plurality of second electrodes extending substantially in the longitudinal dimension, said plurality of first electrodes and said plurality of second electrodes configured to induce substantially linear motion of said second plurality of electrodes in the longitudinal dimension with respect to said first plurality of electrodes as a function of an electric field induced by at least a portion of said first plurality of electrodes.

2. The switched capacitive device in accordance with claim 1, wherein said stator is one of:
substantially rectangular in a plane orthogonal to the longitudinal dimension; and
substantially cylindrical in a plane orthogonal to the longitudinal dimension and extending along the longitudinal dimension.

3. The switched capacitive device in accordance with claim 1, wherein said plurality of first electrodes is embedded within a plurality of first electrode devices.

4. The switched capacitive device in accordance with claim 1, wherein said plurality of second electrodes is embedded within a plurality of second electrode devices.

5. The switched capacitive device in accordance with claim 1, wherein said plurality of first electrodes and said plurality of second electrodes are embedded within an insulated structural material.

6. The switched capacitive device in accordance with claim 1, wherein said plurality of first electrodes and said plurality of second electrodes define a gap therebetween.

7. The switched capacitive device in accordance with claim 6, wherein said gap is at least partially filled with a substantially dielectric fluid.

8. The switched capacitive device in accordance with claim 7, wherein at least a portion of said plurality of first electrodes and at least a portion of said plurality of second electrodes comprise at least one layer of a substantially dielectric material.

9. The switched capacitive device in accordance with claim 8, wherein said at least one layer of substantially dielectric material has a dielectric permittivity substantially similar to a dielectric permittivity of said substantially dielectric fluid.

10. The switched capacitive device in accordance with claim 1, wherein said stator is configured to transmit a plurality of sequential voltage signals through said stator, thereby inducing a cyclic linear motion of said armature in the longitudinal direction.

11. A method of operating a switched capacitive device including a stator and an armature, the switched capacitive device defining a longitudinal dimension, said method comprising:
energizing at least a portion of a plurality of first electrodes within the stator, the plurality of first electrodes extending substantially in the longitudinal dimension;
inducing an electric field about the at least a portion of the first plurality of electrodes, wherein the electric field is further induced about at least a portion of a plurality of second electrodes within the armature proximate the at least a portion of plurality of first electrodes, the plurality of second electrodes extending substantially in the longitudinal dimension; and
inducing linear motion of the armature in the longitudinal direction.

12. The method in accordance with claim 11, wherein inducing an electric field comprises:
successively inducing the electric field along substantially a full length of the first plurality of electrodes; and
inducing linear motion of the armature in the longitudinal direction along substantially the full length of the first plurality of electrodes.

13. The method in accordance with claim 11, wherein inducing an electric field comprises:
sequentially inducing a periodic electric field along substantially a full length of the first plurality of electrodes; and
inducing cyclic linear motion of the armature in the longitudinal direction along substantially the full length of the first plurality of electrodes.

14. A robot comprising:
a body;
a least one electric power source fixedly coupled to said body; and
at least one appendage mechanism translatably coupled to said body, said at least one appendage mechanism comprising at least one switched capacitive device configured to induce movement of said at least one appendage mechanism to generate a motion of said robot, said at least one switched capacitive device comprising:
a stator comprising a plurality of first electrodes extending substantially in a longitudinal dimension; and
an armature comprising a plurality of second electrodes proximate said plurality of first electrodes, said plurality of second electrodes translatable with respect to said plurality of first electrodes, said plurality of second electrodes extending substantially in the longitudinal dimension, said plurality of first electrodes and said plurality of second electrodes configured to induce substantially linear motion of said second plurality of electrodes in the longitudinal dimension with respect to said first plurality of electrodes as a function of an electric field induced by at least a portion of said first plurality of electrodes.

15. The robot in accordance with claim 14, wherein said stator is one of:
substantially rectangular in a plane orthogonal to the longitudinal dimension; and
substantially cylindrical in a plane orthogonal to the longitudinal dimension and extending along the longitudinal dimension.

16. The robot in accordance with claim 14, wherein:
said plurality of first electrodes is embedded within a plurality of first electrode devices; and
said plurality of second electrodes is embedded within a plurality of second electrode devices, wherein said plurality of first electrodes and said plurality of second electrodes are embedded within an insulated structural material.

17. The robot in accordance with claim 14, wherein said plurality of first electrodes and said plurality of second electrodes define a gap therebetween, said gap is at least partially filled with a substantially dielectric fluid.

18. The robot in accordance with claim 17, wherein at least a portion of said plurality of first electrodes and at least a portion of said plurality of second electrodes comprise at least one layer of a substantially dielectric material, wherein said at least one layer of substantially dielectric material has a dielectric permittivity substantially similar to a dielectric permittivity of said substantially dielectric fluid.

19. The robot in accordance with claim 14, wherein said stator is configured to transmit a plurality of sequential voltage signals through said stator, thereby inducing a cyclic linear motion of said armature in the longitudinal direction.

20. The robot in accordance with claim 19 further comprising at least one drive circuit coupled to said stator of said at least one switched capacitive device and said a least one electric power source, said at least one drive circuit comprising:
a plurality of semiconductor devices;
at least one pulse generator coupled to said plurality of semiconductor devices; and
at least one inductive device coupled to said plurality of semiconductor devices.
